(19) United States
(12) Patent Application Publication
(10) Pub. No.: US 2022/0188876 A1
(43) Pub. Date: Jun. 16, 2022

(54) ADVERTISING METHOD AND APPARATUS FOR GENERATING ADVERTISING STRATEGY

(71) Applicant: KAKAO CORP., Jeju-si (KR)

(72) Inventor: Yong Wan GIM, Seongnam-si (KR)

(21) Appl. No.: 17/547,244

(22) Filed: Dec. 10, 2021

(30) Foreign Application Priority Data
Dec. 10, 2020 (KR) 10-2020-0172654

(51) Int. Cl. G06Q 30/02

(52) U.S. Cl. CPC G06Q 30/0276

(57) ABSTRACT

Example embodiments relate to an advertising method and apparatus for generating advertising strategy. The advertising method according to an example embodiment includes acquiring at least one keyword regarding an advertiser, acquiring time series data of a search volume of the keyword, acquiring a trend of the search volume, based on the time series data of the search volume, extracting a search volume corresponding to a present time from the time series data of the search volume, determining whether the search volume corresponding to the present time deviates from the trend of the search volume, and generating an advertisement executing strategy to change attribute information of the advertisement for an advertiser, based on the determination result.

### FIELD OF THE INVENTION

Example embodiments relate to an advertising method and apparatus for generating an advertising strategy.

### DESCRIPTION OF THE RELATED ART

In the marketing, the branding is a process of implanting a good impression for a company itself or products or services of the company to consumers. As a means for branding, advertisement with a goal of consistently exposing a specific impression to the consumers may be used and the advertisement executed as the branding means may be referred to as branding advertisement.

As a method for verifying the effectiveness of the branding advertisement, brand lift survey (BLS) is performed. BLS is a survey for brand recall or brand top-of-mind and verifies the effectiveness of the branding advertisement by classifying consumers exposed to the branding advertisement as an experimental group and consumers who are not exposed to the branding advertisement as a control group to compare the difference in responses of the experimental group and the comparison group. However, the method of verifying the effectiveness of the branding advertisement using BLS consumes a lot of time and money to perform the survey and it takes time from exposing the branding advertisement to the consumers to deriving a result of the survey so that it is disadvantageous in that it is difficult to cope with the change in the interest of the consumers which is changing in real time.

### SUMMARY OF THE INVENTION

### Problem to be Solved

An object of the example embodiment may be to provide a technique for reducing the time and the cost consumed to verify the effectiveness of the branding advertisement.

An object of the example embodiment may be to provide an advertising technique which copes with the interest change of the consumers which are changing in real time.

However, the technical object is not limited to the above-described technique objects, and there may be another technique objects,

### Solution

According to an aspect, an advertising method performed in a processor includes acquiring at least one keyword regarding an advertiser; acquiring time series data of a search volume of the keyword; acquiring a trend of the search volume, based on the time series data of the search volume; extracting a search volume corresponding to a present time from the time series data of the search volume; determining whether the search volume corresponding to the present time deviates from the trend of the search volume; and generating an advertisement executing strategy to change attribute information of the advertisement, based on the determination result.

The attribute information of the advertisement may include at least one of material information of the advertisement, goal information of the advertisement, and budget information of the advertisement.

The generating of an advertisement executing strategy may include: generating an advertisement executing strategy to change goal information of the advertisement, among attribute information the advertisement, when the search volume corresponding to the present time increases by deviating from the trend of the search volume; and generating an advertisement executing strategy to change material information of the advertisement, among attribute information of the advertisement, when the search volume corresponding to the present time decreases by deviating from the trend of the search volume.

The determining of whether to deviate from the trend of the search volume may include: estimating a predictive search volume corresponding to the present time from search volumes of the past times, based on a time series analysis method; and determines whether the search volume corresponding to the present time deviates from the trend of the search volume, based on a difference between the predictive search volume and the search volume corresponding to the present time.

The acquiring of a keyword may include: extracting at least one similar keyword to the keyword.

The acquiring of time series data of a search volume of the keyword may include: a step of acquiring time series data of the search volume of the keyword and the similar keyword.

The acquiring of time series data of a search volume of the keyword may include: acquiring search volume data of the keyword from at least one search engine, at a predetermined period.

When a plurality of keywords is provided, the acquiring of time series data of a search volume may include: acquiring time series data of the search volumes by adding search volumes of the plurality of key words.

When a plurality of keywords is provided, the acquiring of time series data of a search volume may include: acquiring the time series data of the search volume by applying a weight to add search volumes of the plurality of keywords, based on a similarity between the plurality of key words.

The generating of an advertisement executing strategy may include: generating information regarding effectiveness evaluation of the advertisement, based on the trend of the search volume and the trend of an exposure amount of the advertisement.

The advertising method may further include acquiring time series data of the exposure amount of the advertisement, based on the execution result of the advertisement; and acquiring a trend of the exposure amount, based on the time series data of the exposure amount.

The generating of information regarding effectiveness evaluation of the advertisement may include: generating information affirming the effectiveness of the advertisement when a direction of the trend of the search volume and a direction of the trend of the exposure amount are the same; and generating information denying the effectiveness of the advertisement when a direction of the trend of the search volume and a direction of the trend of the exposure amount are different.

The advertising method may further include executing advertisement in which the attribute information is changed, based on the advertisement executing strategy.

According to another aspect, an advertising apparatus includes at least one processor configured to acquire at least one keyword regarding an advertiser, acquire time series data of a search volume of the keyword, acquire a trend of the search volume, based on the time series data of the search volume, extract a search volume corresponding to a present time from the time series data of the search volume, determine whether the search volume corresponding to the present time deviates from the trend of the search volume, and generate an advertisement executing strategy to change attribute information of the advertisement, based on the determination result.

The attribute information of the advertisement may include at least one of material information of the advertisement, goal information of the advertisement, and budget information of the advertisement.

When the advertisement executing strategy is generated, the processor generates an advertisement executing strategy to change goal information of the advertisement, among attribute information of the advertisement, when the search volume corresponding to the present time increases by deviating from the trend of the search volume and may generate an advertisement executing strategy to change material information of the advertisement, among attribute information of the advertisement, when the search volume corresponding to the present time decreases by deviating from the trend of the search volume.

When the processor determines whether to deviate from a trend of the search volume, the processor estimates a predictive search volume corresponding to the present time from search volumes of the past times, based on a time series analysis method and may determine whether the search volume corresponding to the present time deviates from the trend of the search volume, based on a difference between the predictive search volume and the search volume corresponding to the present time.

When the processor acquires the keyword, the processor may extract at least one similar keyword to the keyword.

When the processor acquires time series data of a search volume of the keyword, the processor may acquire time series data of the search volume of the keyword and the similar keyword.

When the processor generates the advertisement executing strategy, the processor acquires time series data of the exposure amount of the advertisement, based on the execution result of the advertisement, acquires a trend of the exposure amount, based on the time series data of the exposure amount, and may generate information regarding effectiveness evaluation of the advertisement, based on the trend of the search volume and the trend of an exposure amount.

When the processor generates information regarding the effectiveness evaluation of the advertisement, the processor generates information affirming the effectiveness of the advertisement when a direction of the trend of the search volume and a direction of the trend of the exposure amount are the same and may generate information denying the effectiveness of the advertisement when a direction of the trend of the search volume and a direction of the trend of the exposure amount are different.

### Effect of Invention

According to the example embodiment, an advertising technique which is capable of changing a marketing strategy in accordance with changes in the external environment, such as the public's interest, by promptly verifying the effectiveness may be provided.

According to the example embodiment, it is possible to efficiently confirm the public's interest in the brand or the effectiveness of the branding advertisement with a reduced advertising budget without spending the money for survey.

The example embodiment may be utilized in parallel with BLS, and advertisers can use it in parallel with BLS to check brand interest that changes in real time while checking brand memory as a middle-term plan and quickly implement a strategy to diversify advertisements in response to changes in the external environment.

The example embodiment may be used for budget distribution balancing to efficiently distribute a limited advertising budget among a plurality of advertising goals.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a view for explaining an advertising method according to an example embodiment;

FIG. 2 is an exemplary diagram of a graph of a search volume trend provided in a search engine according to an example embodiment;

FIGS. 3A to 3C illustrate graphs representing a predictive value and a measurement value for a search volume at each time according to an example embodiment;

FIG. 4 is a view for explaining an advertising method using a similar keyword according to an example embodiment; and

FIG. 5 is an exemplary diagram of a configuration of an apparatus according to an example embodiment.

### DETAILED DESCRIPTION OF INVENTION

Specific structural or functional descriptions for example embodiments are provided for the purpose of illustration only and may be changed in various forms to be implemented. Accordingly, an actually implemented form is not limited only to the specific disclosed example embodiment and the scope of the present specification includes changes, equivalents, or substitutes included in a technical spirit described in the example embodiments.

Even though the terms of first or second are used to describe various components, the terms should be interpreted only to distinguish one component from the other component. For example, a first component may be referred to as a second component, and similarly, a second component may be referred to as a first component.

It should be understood that, when it is described that an element is “connected” to another element, the element may be directly coupled or directly connected to the other element or coupled or connected to the other element through a third element.

A singular form may include a plural form if there is no clearly opposite meaning in the context. In the present specification, it should be understood that terms “include” or “have” indicates that a feature, a number, a step, an operation, a component, a part or the combination those of described in the specification is present, but do not exclude a possibility of presence or addition of one or more other features, numbers, steps, operations, components, parts or combinations, in advance.

If it is not contrarily defined, all terms used herein including technological or scientific terms have the same meaning as those generally understood by a person with ordinary skill in the art. Terminologies which are defined in a generally used dictionary should be interpreted to have the same meaning as the meaning in the context of the related art but are not interpreted as an ideally or excessively formal meaning if it is not clearly defined in this specification.

Hereinafter, example embodiments will be described in detail with reference to the accompanying drawings. In description with reference to accompanying drawings, the same components are denoted by the same reference numerals regardless of the reference numeral and a duplicated description thereof will be omitted.

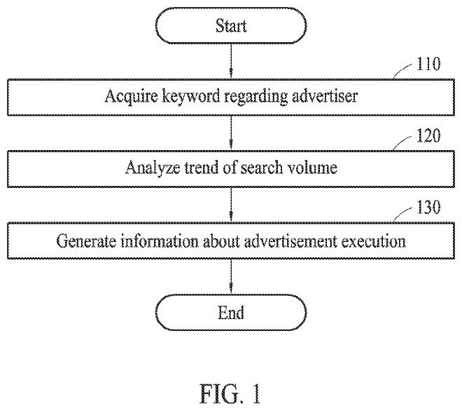

FIG. 1 is a view for explaining an advertising method according to an example embodiment.

Referring to FIG. 1, an advertising method according to an example embodiment may include: a step 110 of acquiring a keyword for estimating an advertising result corresponding to an advertiser, a step 120 of analyzing a trend of a search volume regarding the acquired keyword, and a step 130 of generating information about advertisement execution, such as an advertisement executing strategy, based on a trend analysis. The step 120 of analyzing a trend of a search volume according to the example embodiment may include a step of acquiring search volume data of a keyword from a search volume database, a step of acquiring a trend of the search volume by analyzing the search volume, and a step of determining whether a search volume corresponding to a present time deviates from a trend of the search volume. The steps of the advertising method according to the example embodiment may be performed by at least one processor.

To be more specific, the keyword may include at least one keyword concerning an advertisement or an advertiser. The keyword is a keyword for estimating an advertisement result and for example, may include a name of a company which is an advertiser and a name of a service or a product which is an advertising target, as a keyword for estimating a result of the branding advertisement. According to the example embodiment, the keyword may be input by the advertiser. Alternatively, the keyword may be automatically generated with regard to the advertisement or the advertiser which is a target for estimating the result.

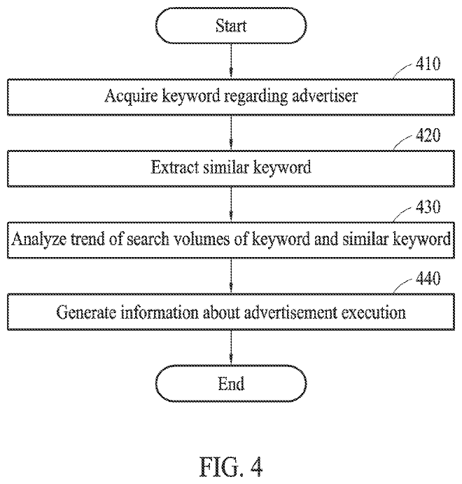

The advertising method according to the example embodiment may further include a step of extracting at least one similar keyword to the acquired keyword. The similar keyword may be extracted by various algorithms which extract similar keywords. For example, the similar keyword may be extracted by a data-mining based algorithm which extracts a similar keyword using a click log of an online website and a deep learning based algorithm using a natural language processing technique. An example embodiment which uses the acquired keyword and the similar keyword will be described below in detail with reference to FIG. 4.

A search volume of the keyword may refer to the number of times that the corresponding keyword is searched through at least one search engine or a search frequency of the corresponding keyword and search volume data of a keyword may include time series data of the number of times of searching the keyword or the search frequency. The time series data of the search volume of the keyword may be acquired from the search volume database which records the number of times of searching a specific keyword through a search engine of users. The search volume database may be managed in the search engine and a processor which performs an operation of the advertising method according to the example embodiment may access the search volume database of the search engine to acquire search volume data for the number of times of searching a keyword.

The processor according to the example embodiment may acquire search volume data at a predetermined time period in response to the specific keyword and acquire search volume data recorded at a predetermined time period in response to the specific keyword. According to the example embodiment, the acquired search volume data may correspond to a specific timing or a specific time interval. For example, 100 times of search volume data for keyword (or search word) “A” may correspond to a z time on the y day of the x month or correspond to a time interval from a z time on the y day of the x month to a (z+1) time on the y day of the x month. When the search volume data may correspond to a specific time, the search volume data may correspond to a search volume collected at the specific time, an accumulative search volume to a specific time, or an average of search volumes for a predetermined time interval.

The processor according to the example embodiment may acquire search volume data at a predetermined time period in response to a specific keyword or acquire search volume data recorded at a predetermined period to acquire time series data of the search volume of the keyword. The time series data may refer to data haying a temporal order, and more particularly, refer to a set of data measured with a predetermined time interval. The time series data of the search volume of the keyword may refer to a set of search volume data measured with a predetermined lag according to a time order. The time lag of the time series data refers to an interval between observation times of the time series data, and for example, may be set to one second, one minute, one hour, one day, or the like. In the same time series data, the time lag may be maintained to be constant.

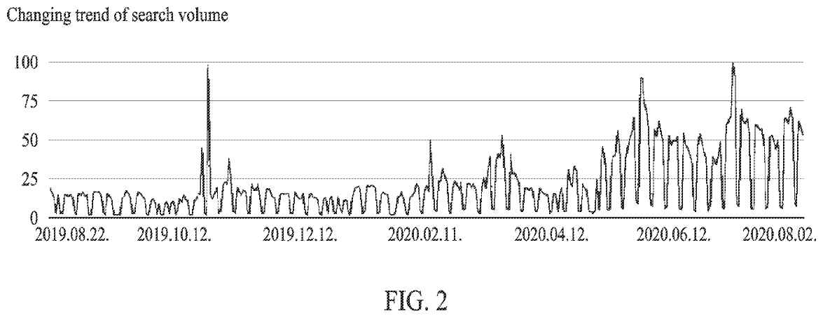

The time series data of the search volume according to the example embodiment may be acquired from the search engine in the term of a search volume changing trend. The search volume changing trend data provided from the search engine may be described with reference to FIG. 2. FIG. 2 illustrates a graph in which a relative ratio of a search volume in which a time haying the largest search volume of the specific keyword searched through the search engine in a set period is set as 100 is represented with a predetermined time interval. The changing trend indicating how the search volume of the specific keyword is changed according to the passage of time may be understood through the graph illustrated in FIG. 2.

Referring to FIG. 1 again, the step 120 of analyzing a trend of the search volume according to the example embodiment may include a step of acquiring a trend of the search volume based on the time series data of the search volume. The trend means a tendency of the change in an observed value according to the passage of time and for example, the tendency of the observed value which increases or decreases according to the passage of time.

The trend of the search volume may be acquired by analyzing the time series data of the search volume according to a time series analysis method. The time series analysis method is an analysis method which aims to understand and predict the change of the observed data according to the passage of time and for example, includes a moving average method. The moving average may refer to an average of a specific number of recent measurement values in the time series data acquired at a predetermined time period. Here, the average may refer to a simple average, an average calculated by applying a weight to the measurement values, and an average calculated by other various methods.

The step 120 of analyzing a trend of a search volume according to the example embodiment may include a step of extracting a search volume corresponding to a present time from the time series data of the search volume and a step of determining whether a search volume corresponding to a present time deviates from a trend of the acquired search volume. The present time may refer to the recent time when the acquired search volume data is acquired. The search volume corresponding to the present time may correspond to the search volume data observed to correspond to the present time (or the recent time) in the time series data of the search volume. In other words, the search volume corresponding to the present time may refer to the latest observed data in the time series data including observed data at a plurality of times.

The acquired trend may include a predictive value at the present time estimated based on the past time series data. The past time series data may correspond to at least some of observed data according to a time order, among observed data of previous times of the present time included in the time series data. For example, the past time series data may include a set of observed data corresponding to a specific number of times close to the present time, according to the time order.

The processor according to the example embodiment estimates the predictive value of the present time based on the past time series data by the time series analysis method, and compares the estimated predictive value of the present time and an actual observed value of the present time to determine whether the observed value of the present time deviates from the trend. It may be determined whether the specific time deviates from the trend based on a difference between an actual value at a specific time and the predictive value. For example, when the difference between the actual value and the predictive value is larger than a predetermined reference value, it may be determined to deviate from the trend and when a ratio of the actual value and the predictive value is larger than a predetermined reference value, it may be determined to deviate from the trend.

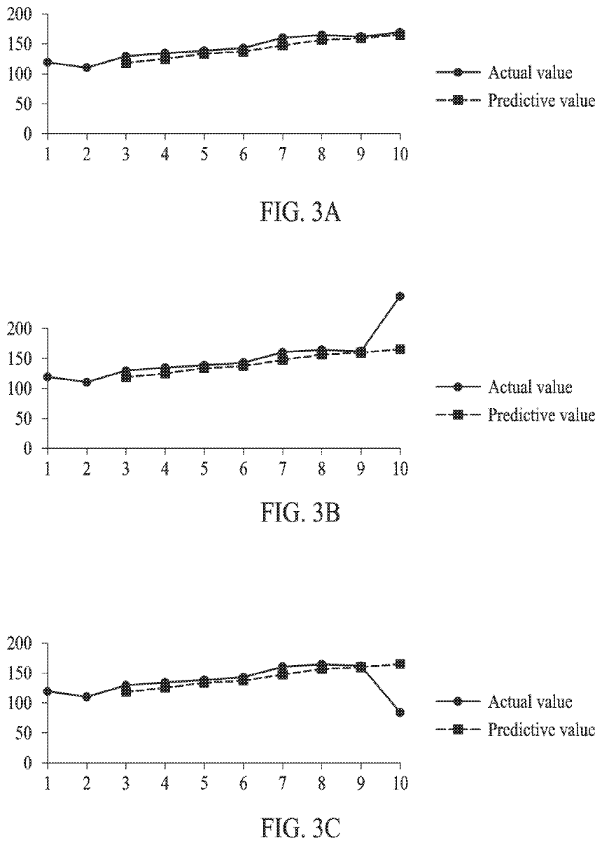

FIGS. 3A to 3C illustrate graphs representing a predictive value and a measurement value for a search volume at each time. In the graphs illustrated in FIGS. 3A to 3C, an x-axis indicates a time and a y-axis indicates a search volume. In FIGS. 3A to 3C, the predictive value refers to a value predicted based on the time series analysis method and the actual value refers to a measured value. Referring to FIG. 3A, graphs of the predictive value and the actual value substantially match at each time (1 to 10), so that it may be determined that the actual value at each time does not deviate from the trend. Referring to FIG. 3B, the actual value is measured to be higher than the predictive value at a time 10, so that it may be determined that it deviates from a trend based on time series data of the past times 1 to 9 at the time 10. Referring to FIG. 3C, the actual value is measured to be lower than the predictive value at a time 10, so that it may be determined that it deviates from a trend based on time series data of the past times 1 to 9 at the time 10.

According to the example embodiment, the trend of the search volume may be acquired according to various time series analysis methods, but in the following description, a method of acquiring a trend by estimating a predictive value at a specific time according to the moving average method which uses a simple average will be described as an example.

A simple average of a specific number of recent measurement values from the time series data which is acquired at a predetermined time period according to the moving average method may be estimated as a predictive value of a subsequent time. To be more specific, when it is assumed that a present time is t and a measurement value at the present time is Zₜ, a moving average Mₜ of n times may be represented by the following Equation 1.

$${M}_{t} = \frac{{Z}_{t} + {Z}_{t - 1} + … + {Z}_{t - n + 1}}{n} \qquad [ Equation 1 ]$$

According to the moving average method, a moving average Mₜ of recent n times may be estimated as a predictive value Fₜ₊₁ of a subsequent time t+1. The predictive value Fₜ₊₁ is a value predicted by the trend based on the past time series data Zₜ₋ₙ₊₁ to Zₜ and the measured value Zₜ₊₁ at a time t+1 may not be equal to Fₜ₊₁. When the observed value Zₜ₊₁ at the time t+1 is acquired, the predictive value Fₜ₊₂ at the time t+2 may be estimated by an average of Zₜ₋ₙ₊₂ to Zₜ₊₁. According to the example embodiment, it may be determined whether the observed value at a specific time deviates from the trend by comparing Fₜ which is the predictive value at each time t and Zₜ.

The moving average in n=1 refers data of previous time so that according to the moving average method in n=1, it may be determined whether to deviate from the trend by comparing actual observation data at a specific time and observation data at a previous time. In other words, it may be determined whether to deviate from a trend at a specific time depending on whether to sharply increase or drop from the observation data at the previous time.

Referring to FIG. 1 again, the step 120 of analyzing a trend of the search volume according to the example embodiment may include a step of acquiring a trend based on a plurality of time series analysis methods. For example, the trend may be acquired based on a moving average method in which n is set to 1 and a moving average method in which n is set to 10. In this case, at the specific time, two predictive values estimated by the moving average methods may be acquired. Whether to deviate from the trend may be determined by whether the observed value at the specific time deviates from both a first predictive value estimated by setting n to 1 and a second predictive value estimated by setting n to 10 or determined whether to deviate from at least one of the first predictive value and the second predictive value. When it is determined whether to deviate from the trend by whether to deviate from at least one of the first predictive value and the second predictive value, it may be determined to deviate from the trend when the observation data of the recent time is sharply increased or decreased from the observation data at a previous time or is equal to or higher than or lower than an average of 10 observation data before the recent time by a predetermined level.

The step 130 of generating of information about advertisement execution according to the example embodiment may include a step of generating information about advertisement execution based on the trend analysis result. The information about advertisement execution is information which is provided to the advertiser to execute the advertisement and for example, may include information about advertisement executing strategy, notification of deviating from the trend, and advertisement effectiveness.

The information about advertisement execution according to the example embodiment may include notification of deviating from the trend and the notification of deviating from the trend may include information about whether a search volume at the present time deviates from the trend and a deviating direction and/or a deviating degree when it deviates from the trend. For example, the information about the advertisement execution may include information indicating that the search volume of the recent time t increases by deviating 10% from a trend to the past time t−1.

The information about the advertisement execution according to the example embodiment may include an advertisement executing strategy. The advertisement executing strategy determines advertisement attribute information such as material information, goal information, and budget information of an advertisement to be transmitted and for example, the advertising strategy may determine an advertisement of a specific material corresponding to a specific object as a transmission target and determine a budget for transmitting the advertisement of the determined target. The advertisement executing strategy may be determined based on a trend analysis result such as a result of determining whether a search volume corresponding to the present time deviates from a trend of the search volume. The advertisement executing strategy is information for the advertiser to be provided to the advertiser and may include an advertisement executing strategy which changes the advertisement attribute information. In other words, the advertisement executing strategy may include information which changes the advertisement attribute information and for example, include information indicating to change a goal of the advertisement, information indicating to change an advertising material, and information indicating to change a budget ratio between the goals of the advertisement or the materials of the advertisement.

The advertisement attribute information is information about a plurality of features which configures the advertisement and for example, may include at least one of the advertising material information, the advertising goal information, and the advertisement budget information. The advertising goal information is an effectiveness to be achieved by transmitting the advertisement and for example, may include brand exposure increase, website visit increase, increases of the number of members, and purchase increase.

According to an example embodiment, the advertising goal information according to the advertisement executing strategy may be changed based on the marketing funnel. The “marketing funnel” is a visual representation with a funnel shape of a number of customers who reaches each step of a series of processes of allowing potential customers to aware a product or a service and visit a website related to the product or the service to subscribe as a member, and purchase. The goal information of the advertisement may be determined by any one of steps which configure the series of processes of the marketing funnel, based on the trend analysis result. For example, when it is determined that a product or service awareness level of the customer is high as the result of analyzing a search volume trend of the keyword, an advertisement executing strategy may be generated to change the goal information of the advertisement to a goal for increasing the visit of the website to induce a step of visiting a website related to the product or the service which corresponds to a subsequent step of the step of being aware of the product or the service in the marketing funnel.

The advertisement executing strategy may be determined based on information derivable based on the trend analysis result of the time series data of the search volume, such as whether a search volume according to the passage of time reaches a target volume, a changed amount of the search volume according to the passage of time, a directivity of the trend, whether to deviate from the trend, or a deviating degree from the trend. In other words, the information about the advertising strategy may be determined according to the content of the information derivable based on the trend analysis result.

According to the example embodiment, the advertisement executing strategy sets information derivable based on the trend analysis result of the time series data of the search volume as a parameter to previously determine an advertisement executing strategy corresponding to each parameter value and/or a combination of the parameter values to generate information about the advertising strategy based on the trend analysis result. For example, a direction of the trend is set as a first parameter which is 1 for a rising direction of the trend and 0 for a falling direction and a deviating degree of the trend is set as a second parameter with (observed value−predictive value). In this case, the advertisement executing strategy according to the parameter may be determined in advance such that when the first parameter is 1 and the second parameter is larger than a first threshold value, information including a first advertisement executing strategy is generated, when the first parameter is 1 and the second parameter is equal to or smaller than the first threshold value, information including a second advertisement executing strategy is generated, when the first parameter is 0 and the second parameter is larger than a third threshold value, information including a third advertisement executing strategy is generated, and when the first parameter is 0 and the second parameter is equal to or smaller than a fourth threshold value, information including a fourth advertisement executing strategy is generated.

According to the example embodiment, when the search volume of the present time is increased by deviating from the trend of the acquired search volume, an advertisement executing strategy which changes goal information of the advertisement among the advertisement attributes may be generated.

The advertising goal is an effectiveness to be achieved by executing the advertisement and for example, may include brand exposure increase, website visit increase, increases of the number of members, and purchase increase. According to the example embodiment, the advertising goal information may correspond to information corresponding to the marketing funnel and for example, may include awareness, comprehension, conviction, and action until a potential customer according to a DAGMAR model purchases a product.

According to the example embodiment, when the search volume of the present time is increased by deviating from a trend based on the search volumes of the past times, information indicating to execute an advertisement having a goal different from that of an advertisement which has been executed in advance or information indicating to execute the advertisement by changing a ratio between goals of the previously executed advertisements may be generated. For example, when the search volume of the present time is increased by deviating from a trend based on the search volumes of the past times, information indicating to change an advertisement having a goal to increase the brand exposure to an advertisement having a goal to increase website visits, increase a number of members, and increase the purchase may be generated.

According to the example embodiment, when the search volume of the present time is decreased by deviating from the trend based on the search volumes of the past times, an advertisement executing strategy which changes material information of the advertisement among the advertisement attributes may be generated.

The advertising materials are contents posted on webpages, applications, or other advertising media to which customers are accessible and may be configured by various types of contents such as texts, images, audios, videos, links, and a combination thereof. Further, the advertising material may be generated by various types suitable for a medium that the advertisement is posted. For example, the advertising material may be generated by various types such as a banner advertisement which is posted on a mobile messenger, a banner advertisement posted on a website, a message format advertisement which is transmitted through a mobile messenger and may be configured to include various contents.

The advertising material may be generated to include various types and contents so as to correspond to a plurality of advertising goals. For example, a branding material (for example, contents including phrases or images to draw attention to a brand name) in response to a goal for increasing brand exposure, a visiting material (for example, contents including a link connected to a website by clicking) in response to a goal for increasing website visits, a material for membership registration (for example, event contents including phrases such as “sign up now and get 2000 won”) in response to a goal for increasing the number of members, and a material for purchase (for example, event contents to provide short-term discount coupons) in response to a goal for increasing purchases may be generated.

According to the example embodiment, when the search volume of the present time is decreased by deviating from a trend based on the search volumes of the past times, information indicating to execute an advertisement having a material different from that of an advertisement which has been executed in advance or information indicating to execute the advertisement by changing a ratio between materials of the previously executed advertisements may be generated. For example, when the search volume of the present time is decreased by deviating from the trend based on the search volumes of the past times, information indicating to execute the advertisement by changing a first advertising material of the branding goal to a second advertising material of the branding goal may be generated and information indicating to execute the advertisement by changing a first advertising material of the branding goal to a third advertising material of a goal for increasing website visits may be generated.

According to the example embodiment, as the analysis result of the search volume, when it is evaluated that a brand awareness reaches a predetermined level based on a predetermined evaluation standard of the brand awareness, information indicating to change a budget ratio between a plurality of goals may be generated to reduce a weight of the advertisement having a branding goal and increase a weight of the advertisement having another goal. The evaluation standard of the brand awareness may include whether the trend of the search volume is increasing or whether the search volume reaches a predetermined level or higher.

The step 130 of generating of information of advertisement according to the example embodiment may further include a step of generating information about evaluation the effectiveness of the advertisement, based on the trend of the search volume of the keyword and the trend of the exposure amount of the advertisement.

The processor according to the example embodiment may analyze the trend of the exposure amount of the advertisement by the same method as the above-described trend analysis method of the search volume and use the trend analysis result of the exposure amount to generate information about evaluation of the effectiveness of the advertisement. For example, the processor may acquire the trend of the exposure amount by acquiring time series data of the exposure amount of the advertisement and analyzing the exposure amount according to the time series analysis method.

The information about evaluation of the effectiveness of the advertisement according to the example embodiment may be generated to include information affirming the effectiveness of the advertisement or information denying the effectiveness of the advertisement based on the trend of the exposure volume of the advertisement and the trend of the search volume of the keyword. For example, when the direction of the trend of the search volume and the direction of the trend of the exposure amount are the same, the information about evaluation of the effectiveness of the advertisement may include information affirming the effectiveness of the advertisement and when the direction of the trend of the search volume and the direction of the trend of the exposure amount are different, the information about evaluation of the effectiveness of the advertisement may include information denying the effectiveness of the advertisement.

The advertising method according to the example embodiment may further include a step of executing an advertisement in which at least one attribute information is changed, based on the generated advertisement executing strategy. For example, the advertising method may further include a step of executing an advertisement by transmitting an advertising material corresponding to the changed advertising goal, based on the advertisement executing strategy generated in the step 130, a step of executing the advertisement by transmitting the changed advertising material, and/or a step of executing the advertisement by changing and transmitting an advertisement weight of the goal according to the changed budget information.

According to the example embodiment, the keyword may include a plurality of keywords. When the plurality of keywords is provided, the time series data of the acquired keyword may include time series data of a plurality of keywords. The processor according to the example embodiment may analyze the trend based on time series data in which time series data of the search volume corresponding to the plurality of keywords are added.

For example, when a first keyword and a second keyword are input by the advertiser, the processor may analyze the trend based on the time series data of the search volume in which a search volume of the first keyword and a search volume of the second keyword are added. The time series data of the search volume of the first keyword and the time series data of the search volume of the second keyword are acquired from the search volume database and a time lag of the time series data of the search volume of the first keyword and a time lag of the time series data of the search volume of the second keyword may be equal to each other.

The processor according to the example embodiment may calculate a sum of time series data corresponding to the plurality of keywords acquired to analyze the trend. The sum of the time series data of the search volume may include a value obtained by adding search volumes of the plurality of keywords corresponding to each time.

For example, when a search volume of the first keyword corresponding to a first time is 100 and a search volume of the second keyword corresponding to a first time is 200, the time series data of the added search volumes may include 300 obtained by adding the search volumes corresponding to the first time as the added search volume data corresponding to the first time.

According to the example embodiment, the added time series data of the search volumes may be acquired by simply adding time series data of the search volumes of the plurality of key words or applying a weight to add the time series data of the search volumes of the plurality of keywords. The weighted sum may be calculated by applying weights corresponding keywords based on the similarity between the plurality of keywords to the search volume of the corresponding keyword to add the time series data. For example, the similarity between the plurality of keywords may be determined by a similar degree between at least one reference keyword and another keyword(s). The reference keyword may be determined based on a predetermined standard such as a degree of association with an advertiser or an advertisement, determined by an advertiser, or arbitrarily determined.

According to the example embodiment, the plurality of keywords may include at least one keyword acquired in association with an advertiser or an advertisement and at least one similar keyword of acquired keyword(s). An example embodiment using a similar keyword will be described with reference to FIG. 4.

Referring to FIG. 4, the advertising method according to the example embodiment may include a step 420 of extracting a similar keyword to the acquired keyword. The method of extracting a similar keyword may include various keyword extracting algorithms.

When the similar keyword is extracted, the step 420 of analyzing a trend of a search volume of the keyword and the similar keyword according to the example embodiment may include a step of acquiring time series data of the search volume of the acquired keyword and the extracted similar keyword.

The trend of the search volumes may be analyzed based on time series data obtained by simply adding time series data of the search volume of the acquired keyword and time series data of the search volume of the similar key word.

According to the example embodiment, the trend of the search volumes may be analyzed based on time series data obtained by applying a weight to and adding time series data of the search volume of the acquired keyword and time series data of the search volume of the similar keyword. For example, a trend of the weighted sum of time series data of the search volume of the acquired keyword and time series data of the search volume of the similar keyword based on the similarity of the acquired keyword and a similar keyword extracted corresponding to the acquired keyword may be analyzed.

The weighted sum may be calculated by applying weights corresponding keywords based on the similarity between the plurality of keywords to the search volume of the corresponding keyword and adding them. For example, the similarity between the plurality of keywords may be determined by a similar degree between at least one reference keyword and another keyword(s). The reference keyword may be determined based on a predetermined standard such as a degree of association with an advertiser or an advertisement, determined by a keyword input by an advertiser, determined by the advertiser, or arbitrarily determined.

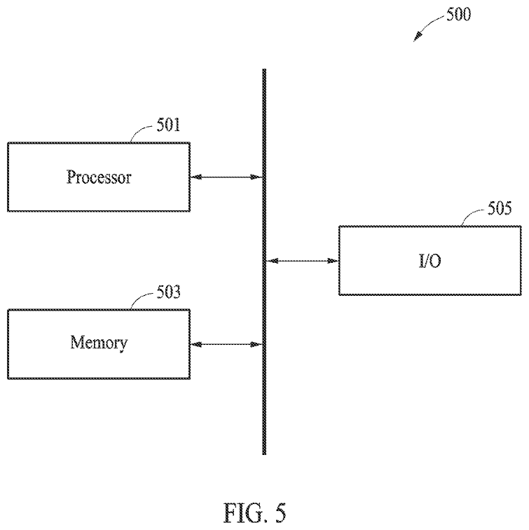

FIG. 5 is an exemplary diagram of a configuration of an apparatus of performing an advertising method according to an example embodiment.

Referring to FIG. 5, the apparatus 500 according to the example embodiment includes at least one processor 501, a memory 503, and an input/output device 505.

The apparatus 500 according to the example embodiment is an apparatus which performs the above-described advertising method and may include a server and a device of a user (or example, a mobile phone, a computer, or the like). In other words, the apparatus 500 may correspond to an apparatus which acquires a keyword regarding an advertiser, estimates a result of the advertisement based on a trend analysis of a search volume for the acquired keyword to generate information about advertisement execution such as an advertisement executing strategy.

At least one processor 501 which configures the apparatus 500 according to the example embodiment may perform at least one advertising method described above with reference to FIGS. 1 to 4 and accesses the above-described search volume database via a network to acquire search volume data of the keyword from the search volume database. The processor 501 accesses the memory 503 which stores data regarding the advertising method according to the example embodiment to record and acquire data. The memory 503 may store information related to the above-described advertising method and the memory 503 may be a volatile memory or a non-volatile memory.

The apparatus 500 according to the example embodiment is connected to an external device (for example, a personal computer or a network) through the input/output device 505 and may exchange data. For example, the apparatus 500 may receive a keyword from the advertiser through the input/output device 505 and output the generated advertisement executing strategy.

The processor 501 may execute a program and control the apparatus 500. Program codes executed by the processor 501 may be stored in the memory 503. In other words, the memory 503 may store a program in which the above-described advertising method is implemented.

The example embodiments described above may be implemented by a hardware component, a software component, and/or a combination of the hardware component and the software component. For example, the device, the method, and the components described in the example embodiments may be implemented, for example, using a general purpose computer or a special purpose computer such as a processor, a controller, an arithmetic logic unit (ALU), a digital signal processor, a microcomputer, a field programmable gate array (FPGA), a programmable logic unit (PLU), a microprocessor, or any other device which executes or responds instructions. The processing device may perform an operating system (OS) and a software application which is executed on the operating system. Further, the processing device may access, store, manipulate, process, and generate data in response to the execution of the software. For ease of understanding, it may be described that a single processing device is used, but those skilled in the art may understand that the processing device includes a plurality of processing elements and/or a plurality of types of processing element. For example, the processing device may include a plurality of processors or include one process and one controller. Further, another processing configuration such as a parallel processor may be allowed.

The software may include a computer program, a code, an instruction, or a combination of one or more of them and configure the processing device to be operated as desired or independently or collectively command the processing device. The software and/or data may be permanently or temporarily embodied in an arbitrary type of machine, component, physical device, virtual equipment, computer storage medium, or device, or signal wave to be transmitted to be interpreted by a processing device or provide command or data to the processing device. The software may be distributed on a computer system connected through a network to be stored or executed in a distributed manner. The software and data may be stored in a computer readable recording medium.

The method according to the example embodiment may be implemented as a program command which may be executed by various computers to be recorded in a computer readable medium. The computer readable medium may include the program instruction, a data file, or a data structure alone or in combination and the program instruction stored in the medium may be specifically designed and configured for the example embodiment or known to be available to those skilled in the art of computer software. Examples of the computer readable recording medium include magnetic media such as a hard disk, a floppy disk, or a magnetic tape, optical media such as a CD-ROM or a DVD, magneto-optical media such as a floptical disk, and a hardware device which is specifically configured to store and execute the program command such as a ROM, a RAM, and a flash memory. Examples of the program command include not only a machine language code which is created by a compiler but also a high level language code which may be executed by a computer using an interpreter.

The above-described hardware device may operate as one or a plurality of software modules in order to perform the operation of the example embodiment and vice versa.

As described above, although example embodiments have been described by limited drawings, those skilled in the art may apply various technical modifications and changes based on the above description. For example, even when the above-described techniques are performed by different order from the described method and/or components such as systems, structures, devices, or circuits described above are coupled or combined in a different manner from the described method or replaced or substituted with other components or equivalents, the appropriate results can be achieved.

Therefore, other implements, other embodiments, and equivalents to the claims are within the scope of the following claims.

What is claimed is:

1. An advertising method performed in a processor, comprising:
acquiring at least one keyword regarding an advertiser;
acquiring time series data of a search volume of the keyword;
acquiring a trend of the search volume, based on the time series data of the search volume;
extracting a search volume corresponding to a present time from the time series data of the search volume;
determining whether the search volume corresponding to the present time deviates from the trend of the search volume; and
generating an advertisement executing strategy to change attribute information of the advertisement, based on the determination result.

2. The advertising method of claim 1, wherein the attribute information of the advertisement includes at least one of material information of the advertisement, goal information of the advertisement, and budget information of the advertisement.

3. The advertising method of claim 1, wherein the generating of an advertisement executing strategy includes:
generating an advertisement executing strategy to change goal information of the advertisement, among attribute information of the advertisement, when the search volume corresponding to the present time increases by deviating from the trend of the search volume; and
generating an advertisement executing strategy to change material information of the advertisement, among attribute information of the advertisement, when the search volume corresponding to the present time decreases by deviating from the trend of the search volume.

4. The advertising method of claim 1, wherein the determining of whether to deviate from the trend of the search volume includes:
estimating a predictive search volume corresponding to the present time from search volumes of the past times, based on a time series analysis method; and
determining whether the search volume corresponding to the present time deviates from the trend of the search volume, based on a difference between the search volume corresponding to the present time and the predictive search volume.

5. The advertising method of claim 1, wherein the acquiring of a keyword includes:
extracting at least one similar keyword to the keyword, and
the acquiring of time series data of a search volume of the keyword includes:
acquiring time series data of search volumes of the keyword and the similar keyword.

6. The advertising method of claim 1, wherein the acquiring of time series data of a search volume of the key word includes:
acquiring search volume data of the keyword from at least one search engine, at a predetermined period.

7. The advertising method of claim 1, wherein when a plurality of keywords is provided, the acquiring of time series data of a search volume includes:
acquiring time series data of the search volumes by adding search volumes of the plurality of keywords.

8. The advertising method of claim 1, wherein when a plurality of keywords is provided, the acquiring of time series data of a search volume includes:
acquiring the time series data of the search volume by applying a weight to add search volumes of the plurality of keywords, based on a similarity between the plurality of keywords.

9. The advertising method of claim 1, wherein the generating of an advertisement executing strategy includes:
generating information regarding effectiveness evaluation of the advertisement, based on the trend of the search volume and the trend of an exposure amount of the advertisement.

10. The advertising method of claim 9, further comprising:
acquiring time series data of the exposure amount of the advertisement, based on the execution result of the advertisement; and
acquiring a trend of the exposure amount, based on the time series data of the exposure amount.

11. The advertising method of claim 9, wherein the generating of information regarding effectiveness evaluation of the advertisement includes:
generating information affirming the effectiveness of the advertisement when a direction of the trend of the search volume and a direction of the trend of the exposure amount are the same; and
generating information denying the effectiveness of the advertisement when a direction of the trend of the search volume and a direction of the trend of the exposure amount are different.

12. The advertising method of claim 1, further comprising:
executing advertisement in which the attribute information is changed, based on the advertisement executing strategy.

13. A computer program which is coupled to hardware to be stored in a medium to execute the advertising method of claim 1.

14. An advertising apparatus, comprising:
at least one processor configured to acquire at least one keyword regarding an advertiser, acquire time series data of a search volume of the keyword, acquire a trend of the search volume, based on the time series data of the search volume, extract a search volume corresponding to a present time from the time series data of the search volume, determine whether the search volume corresponding to the present time deviates from the trend of the search volume, and generate an advertisement executing strategy to change attribute information of the advertisement, based on the determination result.

15. The advertising apparatus of claim 14, wherein the attribute information of the advertisement includes at least one of material information of the advertisement, goal information of the advertisement, and budget information of the advertisement.

16. The advertising apparatus of claim 14, wherein when the advertisement executing strategy is generated, the processor generates an advertisement executing strategy to change goal information of the advertisement, among attribute information of the advertisement, when the search volume corresponding to the present time increases by deviating from the trend of the search volume and generates an advertisement executing strategy to change material information of the advertisement, among attribute information of the advertisement, when the search volume corresponding to the present time decreases by deviating from the trend of the search volume.

17. The advertising apparatus of claim 14, wherein when the processor determines whether to deviate from a trend of the search volume, the processor estimates a predictive search volume corresponding to the present time from search volumes of the past times, based on a time series analysis method and determines whether the search volume corresponding to the present time deviates from the trend of the search volume, based on a difference between the predictive search volume and the search volume corresponding to the present time.

18. The advertising apparatus of claim 14, wherein when the processor acquires the keyword, the processor extracts at least one similar keyword to the keyword, and when the processor acquires time series data of a search volume of the keyword, the processor acquires time series data of search volumes of the keyword and the similar keyword.

19. The advertising apparatus of claim 14, wherein when the processor generates the advertisement executing strategy, the processor acquires time series data of the exposure amount of the advertisement, based on the execution result of the advertisement, acquires a trend of the exposure amount, based on the time series data of the exposure amount, and generates information regarding effectiveness evaluation of the advertisement, based on the trend of the search volume and the trend of the exposure amount.

20. The advertising apparatus of claim 19, wherein when the processor generates information regarding the effectiveness evaluation of the advertisement, the processor generates information affirming the effectiveness of the advertisement when a direction of the trend of the search volume and a direction of the trend of the exposure amount are the same and generates information denying the effectiveness of the advertisement when the direction of the trend of the search volume and the direction of the trend of the exposure amount are different.
